(19) United States
(12) Patent Application Publication
(10) Pub. No.: US 2019/0080529 A1
(43) Pub. Date: Mar. 14, 2019

(54) SYSTEMS AND METHODS TO DETECT ABNORMALITIES IN A VEHICLE SUSPENSION SYSTEM

(71) Applicant: GM GLOBAL TECHNOLOGY OPERATIONS LLC, Detroit, MI (US)

(72) Inventors: Brian K. Saylor, South Lyon, MI (US); Joshua R. Auden, Brighton, MI (US); Robert P. Marble, WHITE LAKE, MI (US)

(21) Appl. No.: 15/700,706

(22) Filed: Sep. 11, 2017

(51) Int. Cl. G07C 5/08; B60C 23/04

(52) U.S. Cl. CPC G07C 5/0808; B60C 23/0488; G07C 5/0816

(57) ABSTRACT

An exemplary method to detect a wear condition of a vehicle damper includes the steps of receiving tire condition data from a vehicle sensor, calculating an amplitude of the tire condition data as a function of frequency, monitoring the amplitude of the tire condition data within a predetermined frequency range, determining whether the amplitude of the tire condition data is greater than a predetermined threshold and, if the amplitude is greater than the predetermined threshold, increasing an oscillation count by one, and comparing the oscillation count to a predetermined count threshold.

### INTRODUCTION

The present invention relates generally to the field of vehicles and, more specifically, to systems and methods to detect abnormalities in one or more components of a vehicle suspension system.

Dampers and other suspension components can degrade or fail suddenly and at different intervals and are considered a safety issue with regard to vehicle handling. However, the state of health of suspension components, including vehicle damper system components, is often not identified by the vehicle operator until the component has degraded to a point where the suspension component or other vehicle components may be damaged.

### SUMMARY

Embodiments according to the present disclosure provide a number of advantages. For example, embodiments according to the present disclosure enable detection of abnormalities in vehicle suspension components, such as vehicle dampers or shock absorbers, by monitoring tire pressure and/or acceleration data received from the tire pressure sensor associated with the vehicle wheel/tire.

In one aspect, a method to detect a wear condition of a vehicle damper includes the steps of receiving tire condition data from a vehicle sensor, calculating an amplitude of the tire condition data as a function of frequency, monitoring the amplitude of the tire condition data within a predetermined frequency range, determining whether the amplitude of the tire condition data is greater than a predetermined threshold and, if the amplitude is greater than the predetermined threshold, increasing an oscillation count by one, and comparing the oscillation count to a predetermined count threshold.

In some aspects, receiving tire condition data from the vehicle sensor includes receiving one or more of tire pressure data and tire acceleration data from a tire pressure and acceleration sensor associated with a vehicle tire.

In some aspects, the predetermined frequency range is 10-14 Hz.

In some aspects, the vehicle sensor includes a tire pressure monitoring sensor associated with a vehicle tire.

In some aspects, the method further includes the step of transmitting a diagnostic notification if the oscillation count is above the predetermined count threshold.

In some aspects, comparing the oscillation count to the predetermined count threshold includes comparing the oscillation count to the predetermined count threshold over a predetermined interval.

In some aspects, the predetermined interval is one of a predetermined time and a predetermined distance of travel.

In another aspect, a system to detect a wear condition of a vehicle damper includes at least one tire pressure sensor and an electronic controller in electronic communication with the at least one tire pressure sensor. The electronic controller is configured to receive tire pressure data from the tire pressure sensor, calculate an amplitude of the tire pressure data as a function of frequency, monitor the amplitude of the tire pressure data within a predetermined frequency range, determine whether the amplitude of the tire pressure data is greater than a predetermined threshold and, if the amplitude is greater than the predetermined threshold, increasing an oscillation count by one, and compare the oscillation count to a predetermined count threshold.

In some aspects, the predetermined frequency range is 10-14 Hz.

In some aspects, the electronic controller is further configured to transmit a diagnostic notification if the oscillation count is above the predetermined count threshold.

In some aspects, transmitting the diagnostic notification includes one or more of setting a diagnostic code and displaying a notification.

In some aspects, comparing the oscillation count to the predetermined count threshold includes comparing the oscillation count to the predetermined count threshold over a predetermined interval.

In some aspects, the predetermined interval is one of a predetermined time and a predetermined distance of travel of the vehicle.

In yet another aspect, an automotive vehicle includes a wheel including a tire, a tire pressure sensor coupled to the wheel, and an electronic controller coupled to the tire pressure sensor. The tire pressure sensor is configured to receive tire pressure data from the tire, calculate an amplitude of the tire pressure data as a function of frequency, monitor the amplitude of the tire pressure data within a predetermined frequency range, and determine whether the amplitude of the tire pressure data is greater than a predetermined threshold and, if the amplitude is greater than the predetermined threshold, transmit a signal to the electronic controller to increase an oscillation count.

In some aspects, the predetermined frequency range is 10-14 Hz.

In some aspects, the electronic controller is further configured to transmit a diagnostic notification if the oscillation count is above a predetermined count threshold.

In some aspects, transmitting the diagnostic notification includes one or more of setting a diagnostic code and displaying a notification.

In some aspects, the electronic controller is further configured to compare the oscillation count to a predetermined count threshold.

In some aspects, comparing the oscillation count to the predetermined count threshold includes comparing the oscillation count to the predetermined count threshold over a predetermined interval.

### BRIEF DESCRIPTION OF THE DRAWINGS

The present disclosure will be described in conjunction with the following figures, wherein like numerals denote like elements.

FIG. 1 is a schematic diagram of a vehicle having a suspension monitoring system, according to an embodiment.

FIG. 2A is a graphical representation of tire pressure/tire bounce as a function of distance from a road irregularity for tires having dampers of various wear profiles, according to an embodiment.

FIG. 2B is a graphical representation of damper response to a road irregularity as a function of time or distance from the road irregularity for dampers of various wear profiles, according to an embodiment.

FIG. 3 is a graphical representation of the amplitude of two tire pressure signals with reference to a specified frequency band, according to an embodiment.

FIG. 4 is a schematic flow diagram of a method to determine whether one or more suspension system components, such as one or more vehicle dampers, are functioning properly to provide acceptable vehicle stability, according to an embodiment.

The foregoing and other features of the present disclosure will become more fully apparent from the following description and appended claims, taken in conjunction with the accompanying drawings. Understanding that these drawings depict only several embodiments in accordance with the disclosure and are not to be considered limiting of its scope, the disclosure will be described with additional specificity and detail through the use of the accompanying drawings. Any dimensions disclosed in the drawings or elsewhere herein are for the purpose of illustration only.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the present invention. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

Certain terminology may be used in the following description for the purpose of reference only, and thus are not intended to be limiting. For example, terms such as “above” and “below” refer to directions in the drawings to which reference is made. Terms such as “front,” “back,” “left,” “right,” “rear,” and “side” describe the orientation and/or location of portions of the components or elements within a consistent but arbitrary frame of reference which is made clear by reference to the text and the associated drawings describing the components or elements under discussion. Moreover, terms such as “first,” “second,” “third,” and so on may be used to describe separate components. Such terminology may include the words specifically mentioned above, derivatives thereof, and words of similar import.

Processes and systems disclosed herein use tire pressure and/or acceleration monitoring sensors to detect abnormalities in the performance of suspension system components, such as, for example and without limitation, vehicle dampers or shock absorbers, by measuring the tire pressure and/or accelerations within the wheel and/or the tire. In some embodiments, the pressure pulsations can be monitored against a predetermined threshold of frequency-based limits. If the predetermined limits are exceeded, the signal can be used, in some embodiments, to notify the vehicle operator of a potential issue. Additionally, in some embodiments, the pressure pulsations can be monitored to detect potential wheel imbalance issues.

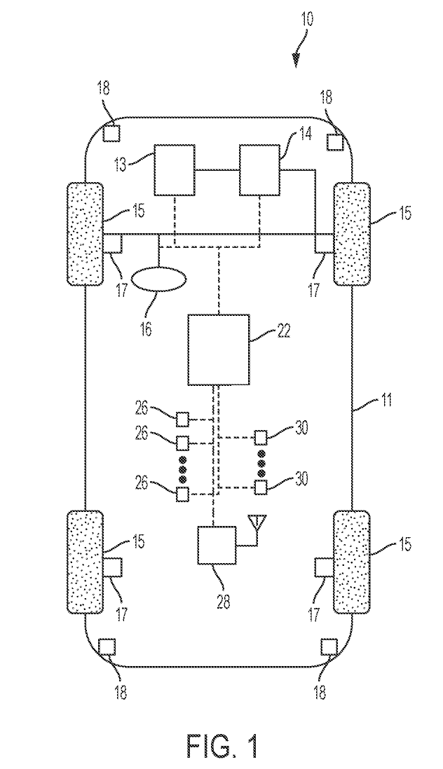

FIG. 1 schematically illustrates an automotive vehicle 10 according to the present disclosure. The vehicle 10 generally includes a body 11 and wheels or tires 15. The body 11 encloses the other components of the vehicle 10. The wheels 15 are each rotationally coupled to the body 11 near a respective corner of the body 11. The vehicle 10 is depicted in the illustrated embodiment as a passenger car, but it should be appreciated that any other vehicle, including motorcycles, trucks, sport utility vehicles (SUVs), or recreational vehicles (RVs), etc., can also be used. In some embodiments, the vehicle 10 is an autonomous or semi-autonomous vehicle. In some embodiments, the vehicle 10 is operated directly by a vehicle operator.

The vehicle 10 includes a propulsion system 13, which may in various embodiments include an internal combustion engine, an electric machine such as a traction motor, and/or a fuel cell propulsion system. The vehicle 10 also includes a transmission 14 configured to transmit power from the propulsion system 13 to the plurality of vehicle wheels 15 according to selectable speed ratios. According to various embodiments, the transmission 14 may include a step-ratio automatic transmission, a continuously-variable transmission, or other appropriate transmission. The vehicle 10 additionally includes wheel brakes (not shown) configured to provide braking torque to the vehicle wheels 15. The wheel brakes may, in various embodiments, include friction brakes, a regenerative braking system such as an electric machine, and/or other appropriate braking systems. The vehicle 10 additionally includes a steering system 16. While depicted as including a steering wheel and steering column for illustrative purposes, in some embodiments, the steering system 16 may not include a steering wheel. The vehicle 10 additionally includes one or more suspension system components, such as vehicle dampers or shock absorbers 17. In some embodiments, as shown in FIG. 1, a vehicle damper 17 is positioned adjacent to each of the wheels 15.

In various embodiments, the vehicle 10 also includes a navigation system 28 configured to provide location information in the form of GPS coordinates (longitude, latitude, and altitude/elevation) to a controller 22. In some embodiments, the navigation system 28 may be a Global Navigation Satellite System (GNSS) configured to communicate with global navigation satellites to provide autonomous geo-spatial positioning of the vehicle 10. In the illustrated embodiment, the navigation system 28 includes an antenna electrically connected to a receiver. The navigation system 28 may be used, in some embodiments, to provide data to the controller 22 to guide the vehicle 10 to a service facility for service or replacement of one or more suspension components, for example and without limitation.

With further reference to FIG. 1, the vehicle 10 also includes a plurality of sensors 26 configured to measure and capture data on one or more vehicle characteristics, including but not limited to vehicle speed, tire pressure and/or acceleration, and vehicle acceleration. In the illustrated embodiment, the sensors 26 include, but are not limited to, an accelerometer, a speed sensor, a tire pressure/acceleration monitoring sensor, gyroscope, steering angle sensor, or other sensors that sense observable conditions of the vehicle or the environment surrounding the vehicle and may include RADAR, LIDAR, optical cameras, thermal cameras, ultrasonic sensors, infrared sensors, light level detection sensors, and/or additional sensors as appropriate. In some embodiments, a tire pressure and/or acceleration monitoring sensor (tire pressure monitoring sensor or TPMS) 26 is associated with the tire of each wheel 15. Each of the TPMS 26 provides tire pressure data and/or tire acceleration data of the associated vehicle tire. In some embodiments, a near field communication (NFC) device 18 is located adjacent to one or more corners of the vehicle 10 and is located, in some embodiments, in the wheel well of the vehicle 10 such that an NFC 18 is in proximity to each of the TPMS 26. The NFC device 18 is configured to communicate with the TPMS 26 associated with the wheel 15 that is closest in proximity to the NFC device 18 and transmit the information received from the associated TPMS 26 to a vehicle controller, such as the controller 22 discussed herein. In some embodiments, the vehicle 10 also includes a plurality of actuators 30 configured to receive control commands to control steering, shifting, throttle, braking or other aspects of the vehicle 10.

The vehicle 10 includes at least one controller 22. While depicted as a single unit for illustrative purposes, the controller 22 may additionally include one or more other controllers, collectively referred to as a “controller.” The controller 22 may include a microprocessor or central processing unit (CPU) or graphical processing unit (GPU) in communication with various types of computer readable storage devices or media. Computer readable storage devices or media may include volatile and nonvolatile storage in read-only memory (ROM), random-access memory (RAM), and keep-alive memory (KAM), for example. KAM is a persistent or non-volatile memory that may be used to store various operating variables while the CPU is powered down. Computer-readable storage devices or media may be implemented using any of a number of known memory devices such as PROMs (programmable read-only memory), EPROMs (electrically PROM), EEPROMs (electrically erasable PROM), flash memory, or any other electric, magnetic, optical, or combination memory devices capable of storing data, some of which represent executable instructions, used by the controller 22 in controlling the vehicle.

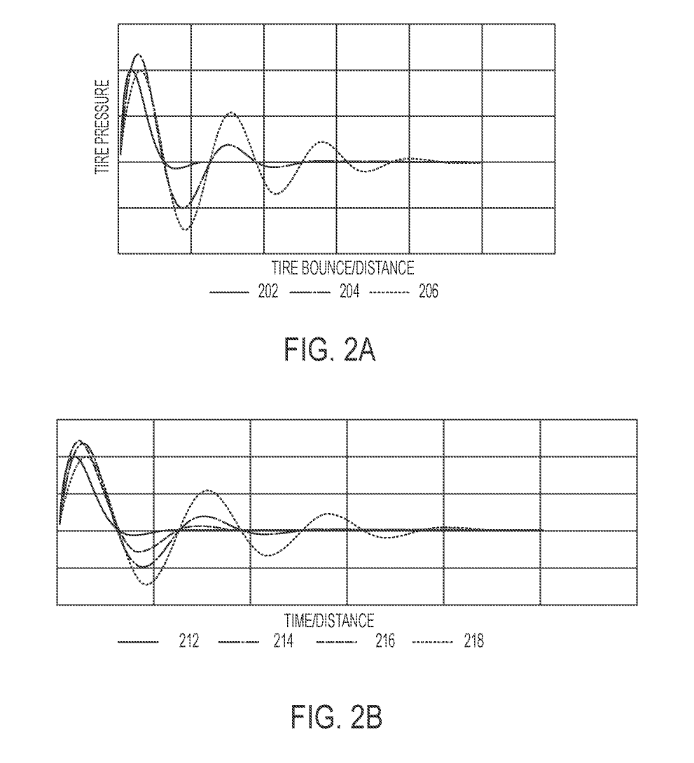

An indication of vehicle damper condition is depicted graphically in FIGS. 2A and B. FIG. 2A illustrates the measured tire pressure as the vehicle passes over a bump or other road irregularity. For a tire with a functional damper, the tire pressure shown as line 202 has an initial peak when the tire goes over the irregularity but after the initial peak the bounce quickly attenuates due to the damping effects of the vehicle damper 17. In contrast, a moderately worn damper 17 results in a tire pressure line 204 having multiple peaks and a longer distance/time until the bounce attenuates. Similarly, and more dramatically, for a completely worn vehicle damper 17, the tire pressure line 206 has an initial peak as well as several peaks over a greater distance/time, with attenuation occurring at a much further distance/time from the initial road irregularity.

The condition of the vehicle damper 17, shown in FIG. 2B, is correlated with the tire pressures illustrated in FIG. 2A. For a new vehicle damper 17, line 212 illustrates an initial peak with attenuation occurring shortly after the initial peak, correlating with the pressure line 202. Similarly, for a leaking vehicle damper (line 214) and a worn vehicle damper exhibiting normal wear (for example and without limitation, a damper having approximately 25,000 miles of use, shown as line 216), the initial peak is followed by smaller peaks prior to attenuation at a distance or time further from the road irregularity, correlating with the tire pressure line 204. Finally, for a vehicle damper that is completely worn or has significant wear and may need repair or replacement (line 218), the initial peak is followed by several peaks continuing for a longer time and/or distance after the vehicle travels over the irregularity, correlating with the pressure line 206.

The tire pressure/acceleration monitoring sensors (TPMS) 26 monitor and compute oscillations within a narrow frequency band, typically 10-14 Hz. This frequency band corresponds to a wheel hop frequency resulting from the vehicle 10 passing over a bump or other road irregularity. Each TPMS 26 detects an oscillation of the associated wheel 15 within this frequency band via a measured pressure change. As shown, oscillations having the greatest amplitude occur within a narrow frequency band. If the root mean square (RMS) value of the total oscillations exceeds a threshold over a predetermined time interval, the vehicle operator can be notified or a diagnostic code may be triggered.

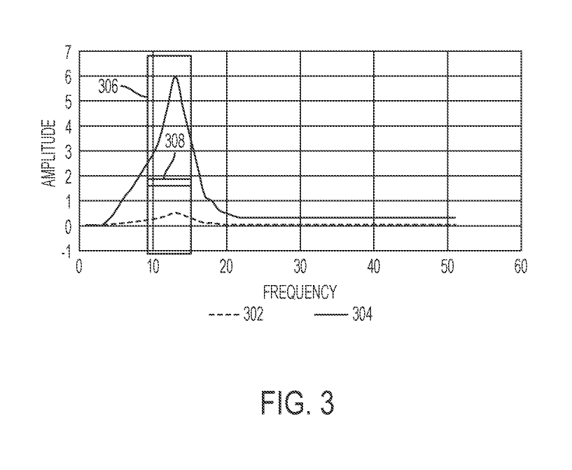

FIG. 3 illustrates the FFT of two pressure signals received by the controller 22 from one or more of the TPMS 26 sensors of the vehicle 10. The signal received from the TPMS 26 on a tire having a functional vehicle damper 17 is shown as line 302. The signal received from the TPMS 26 on an undamped tire or a tire having a worn damper is shown as line 304. As shown in FIG. 3, the undamped signal 304 has a much greater amplitude than the signal 302 received from the damped tire within the monitored frequency band 306 of approximately 10-14 Hz. The amplitude of the FFT of the tire pressure signal received from one or more TPMS 26 is compared against a predetermined threshold 308. The predetermined threshold 308 depends on the vehicle type and/or configuration, among other considerations.

If the amplitude of a predetermined count of pressure or acceleration oscillations within the monitored frequency band exceeds the predetermined threshold 308 over a predetermined time interval and/or distance of vehicle travel, a potential issue with one or more vehicle dampers may exist. In some embodiments, one or more of the TPMS 26 and/or one or more of the NFC 18 communicate the tire pressure information to the vehicle controller 22 which may, in turn, transmit a diagnostic notification which includes displaying a notification to the vehicle operator or setting a diagnostic code, as discussed in greater detail herein.

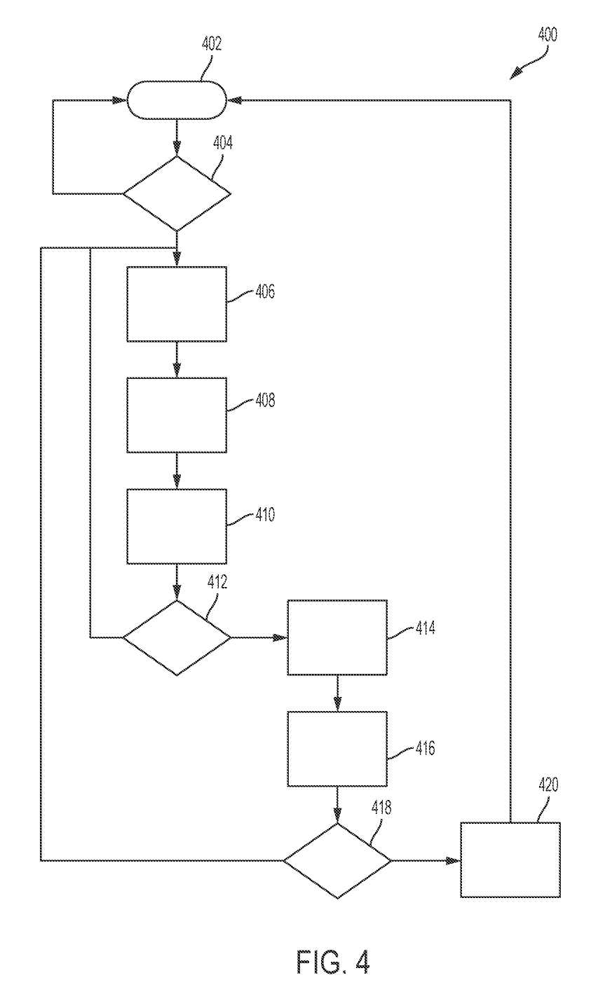

FIG. 4 illustrates a method 400 to determine whether one or more suspension system components, such as one or more of the vehicle dampers 17, is functioning properly to provide acceptable vehicle stability. The method 400 can be utilized in connection with a vehicle having one or more sensors 26, such as the vehicle 10. In some embodiments, some or all of the steps of the method 400 are performed by the TPMS 26. In some embodiments, the method 400 can be utilized in connection with a controller 22 or vehicle electronic control unit (ECU) as discussed herein, or by other systems associated with or separate from the vehicle 10, in accordance with exemplary embodiments. The order of operation of the method 400 is not limited to the sequential execution as illustrated in FIG. 4 but may be performed in one or more varying orders, or steps may be performed simultaneously, as applicable in accordance with the present disclosure.

As shown in FIG. 4, the method 400 starts at 402 and proceeds to 404. At 404, the controller or the TPMS determines whether the vehicle 10 is moving. For example, in some embodiments, a vehicle speed sensor, one of the sensors 26, associated with the controller 22 determines whether the vehicle speed is above a predetermined threshold, such as 3 kph. If the vehicle is not moving, the method 400 returns to the start at 402. If the vehicle 10 is moving, the TPMS 26 begins monitoring operation and the method 400 proceeds to 406.

At 406, the TPMS 26 monitors the tire pressure and/or the triaxial acceleration of the associated tire 15. Next, at 408, the TPMS 26 transforms the time- or distance-based tire pressure and/or acceleration oscillation signal to a frequency domain signal using, for example, a fast Fourier transform. At 410, the TPMS 26 monitors a predetermined frequency band, such as, for example and without limitation, approximately 10-14 Hz, for frequency-domain oscillations. Next, at 412, the TPMS 26 determines whether the monitored frequency-domain oscillation exceeds the predetermined threshold 308. If the oscillation does not exceed the threshold, the method 400 returns to 406 and the method 400 proceeds as discussed herein.

However, if the oscillation exceeds the predetermined threshold, the method 400 proceeds to 414. At 414, the TPMS 26 transmits a signal to the closest near field communication (NFC) device 18. The signal transmitted to the NFC device 18 indicates a fault or detected oscillation above the threshold. In some embodiments, the NFC device 18 maintains a count of the fault signals transmitted by the TPMS 26. In some embodiments, the NFC device 18 transmits the fault signal received from the TPMS 26 to the controller 22 and the controller 22 maintains a count of the fault signals received from the associated TPMS 26. In some embodiments, the controller 22 maintains a count of the fault signals received from each of the TPMS 26 associated with one of the wheels 15. In some embodiments, each TPMS 26 maintains a count of the fault signal triggered by the associated wheel 15 and transmits this information to the associated NFC 18, which in turn transmits the fault signal information to the controller 22 for additional analysis.

Next, at 416, a fault oscillation counter, that is, the count of fault oscillation signals maintained, in some embodiments, by the NFC device 18 and/or the controller 22 and/or the TPMS 26, is increased by one. In some embodiments, the controller 22 communicates with the NFC device(s) 18 and receives one or more signals indicating the count of fault oscillations signals.

After increasing the fault oscillation counter, the method 400 proceeds to 418. At 418, the controller 22 monitors the fault oscillation counter(s) received from the NFC device(s) 18 to determine if the count of detected oscillations above or below the predetermined oscillation amplitude threshold recorded by the counter is above a predetermined oscillation count. In some embodiments, for example, the predetermined oscillation count is 10 oscillation occurrences over a predetermined interval, such as, for example and without limitation, the last 10 miles of vehicle operation or within a single key cycle. In other embodiments, the predetermined oscillation count over the predetermined threshold could be more or fewer than 10, such as, for example and without limitation, 5, 8, 12, 15, or more occurrences over a specified time and/or distance interval. As discussed herein with respect to FIG. 3, a series of oscillations above the predetermined threshold 308 indicates a possible issue with one or more of the vehicle dampers 17, such as, for example and without limitation, a worn or leaking damper.

If the fault oscillation counter is above the predetermined oscillation count, the method 400 proceeds to 420 and the controller 22 transmits a diagnostic notification, such as, for example and without limitation, an indication of a possible vehicle damper issue. In some embodiments, transmitting the diagnostic notification includes setting a diagnostic trouble code (DTC), transmitting a diagnostic code via a wireless communication system, or displaying a notification to the vehicle operator. In some embodiments, the vehicle operator is notified of the potential issue and may be instructed to direct the vehicle to a service facility for evaluation and repair or replacement of one or more of the vehicle dampers 17. In some embodiments, the controller 22 may direct and/or control the autonomous or semi-autonomous vehicle to a service facility for evaluation and repair or replacement of one or more of the vehicle dampers 17. In some embodiments, from 420, the method 400 returns to the start at 402 and the method 400 runs continuously.

If the fault oscillation counter is not above the predetermined oscillation count, the method 400 returns to 406 and the method 400 proceeds as discussed herein.

While some or all of the steps of the method 400 are discussed herein as being performed by one TPMS 26, it should be appreciated that any and/or all of the TPMS 26 associated with the wheels 15 may perform the method 400 concurrently, and in association with the controller 22, such that data from all of the tires or any subset of the tires of the vehicle 10 are continuously monitored.

It should be emphasized that many variations and modifications may be made to the herein-described embodiments, the elements of which are to be understood as being among other acceptable examples. All such modifications and variations are intended to be included herein within the scope of this disclosure and protected by the following claims. Moreover, any of the steps described herein can be performed simultaneously or in an order different from the steps as ordered herein. Moreover, as should be apparent, the features and attributes of the specific embodiments disclosed herein may be combined in different ways to form additional embodiments, all of which fall within the scope of the present disclosure.

Conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements and/or states. Thus, such conditional language is not generally intended to imply that features, elements and/or states are in any way required for one or more embodiments or that one or more embodiments necessarily include logic for deciding, with or without author input or prompting, whether these features, elements and/or states are included or are to he performed in any particular embodiment.

Moreover, the following terminology may have been used herein. The singular forms “a,” “an,” and “the” include plural referents unless the context clearly dictates otherwise. Thus, for example, reference to an item includes reference to one or more items. The term “ones” refers to one, two, or more, and generally applies to the selection of some or all of a quantity. The term “plurality” refers to two or more of an item. The term “about” or “approximately” means that quantities, dimensions, sizes, formulations, parameters, shapes and other characteristics need not be exact, but may he approximated and/or larger or smaller, as desired, reflecting acceptable tolerances, conversion factors, rounding off, measurement error and the like and other factors known to those of skill in the art. The term “substantially” means that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

Numerical data may be expressed or presented herein in a range format. it is to be understood that such a range format is used merely for convenience and brevity and thus should be interpreted flexibly to include not only the numerical values explicitly recited as the limits of the range, but also interpreted to include all of the individual numerical values or sub-ranges encompassed within that range as if each numerical value and sub-range is explicitly recited. As an illustration, a numerical range of “about 1 to 5” should be interpreted to include not only the explicitly recited values of about 1 to about 5, but should also be interpreted to also include individual values and sub-ranges within the indicated range. Thus, included in this numerical range are individual values such as 2, 3 and 4 and sub-ranges such as “about 1 to about 3,” “about 2 to about 4” and “about 3 to about 5,” “1 to 3,” “2 to 4,” “3 to 5,” etc. This same principle applies to ranges reciting only one numerical value (e.g., “greater than about 1”) and should apply regardless of the breadth of the range or the characteristics being described. A plurality of items may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary. Furthermore, where the terms “and” and “or” are used in conjunction with a list of items, they are to be interpreted broadly, in that any one or more of the listed items may be used alone or in combination with other listed items. The term “alternatively” refers to selection of one of two or more alternatives, and is not intended to limit the selection to only those listed alternatives or to only one of the listed alternatives at a time, unless the context clearly indicates otherwise.

The processes, methods, or algorithms disclosed herein can be deliverable to/implemented by a processing device, controller, or computer, which can include any existing programmable electronic control unit or dedicated electronic control unit. Similarly, the processes, methods, or algorithms can be stored as data and instructions executable by a controller or computer in many forms including, but not limited to, information permanently stored on non-writable storage media such as ROM devices and information alterably stored on writeable storage media such as floppy disks, magnetic tapes, CDs, RAM devices, and other magnetic and optical media. The processes, methods, or algorithms can also be implemented in a software executable object. Alternatively, the processes, methods, or algorithms can be embodied in whole or in part using suitable hardware components, such as Application Specific Integrated Circuits (ASICs), Field-Programmable Gate Arrays (FPGAs), state machines, controllers or other hardware components or devices, or a combination of hardware, software and firmware components. Such example devices may be on-board as part of a vehicle computing system or be located off-board and conduct remote communication with devices on one or more vehicles.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further exemplary aspects of the present disclosure that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and can be desirable for particular applications.

What is claimed is:

1. A method to detect a wear condition of a vehicle damper, the method comprising:
receiving tire condition data from a vehicle sensor;
calculating an amplitude of the tire condition data as a function of frequency;
monitoring the amplitude of the tire condition data within a predetermined frequency range;
determining whether the amplitude of the tire condition data is greater than a predetermined threshold and, if the amplitude is greater than the predetermined threshold, increasing an oscillation count by one; and
comparing the oscillation count to a predetermined count threshold.

2. The method of claim 1, wherein receiving tire condition data from the vehicle sensor comprises receiving one or more of tire pressure data and tire acceleration data from a tire pressure and acceleration sensor associated with a vehicle tire.

3. The method of claim 2, wherein the predetermined frequency range is 10-14 Hz.

4. The method of claim 1, wherein the vehicle sensor comprises a tire pressure monitoring sensor associated with a vehicle tire.

5. The method of claim 4, further comprising transmitting a diagnostic notification if the oscillation count is above the predetermined count threshold.

6. The method of claim 1, wherein comparing the oscillation count to the predetermined count threshold comprises comparing the oscillation count to the predetermined count threshold over a predetermined interval.

7. The method of claim 6, wherein the predetermined interval is one of a predetermined time and a predetermined distance of travel.

8. A system to detect a wear condition of a vehicle damper, comprising:
at least one tire pressure sensor; and
an electronic controller in electronic communication with the at least one tire pressure sensor, the electronic controller configured to
receive tire pressure data from the tire pressure sensor;
calculate an amplitude of the tire pressure data as a function of frequency;
monitor the amplitude of the tire pressure data within a predetermined frequency range;
determine whether the amplitude of the tire pressure data is greater than a predetermined threshold and, if the amplitude is greater than the predetermined threshold, increasing an oscillation count by one; and
compare the oscillation count to a predetermined count threshold.

9. The system of claim 8, wherein the predetermined frequency range is 10-14 Hz.

10. The system of claim 8, wherein the electronic controller is further configured to transmit a diagnostic notification if the oscillation count is above the predetermined count threshold.

11. The system of claim 10, wherein transmitting the diagnostic notification comprises one or more of setting a diagnostic code and displaying a notification.

12. The system of claim 8, wherein comparing the oscillation count to the predetermined count threshold comprises comparing the oscillation count to the predetermined count threshold over a predetermined interval.

13. The system of claim 12, wherein the predetermined interval is one of a predetermined time and a predetermined distance of travel of the vehicle.

14. An automotive vehicle, comprising:
a wheel comprising a tire;
a tire pressure sensor coupled to the wheel; and
an electronic controller coupled to the tire pressure sensor;
wherein the tire pressure sensor is configured to
receive tire pressure data from the tire;
calculate an amplitude of the tire pressure data as a function of frequency;
monitor the amplitude of the tire pressure data within a predetermined frequency range; and
determine whether the amplitude of the tire pressure data is greater than a predetermined threshold and, if the amplitude is greater than the predetermined threshold, transmit a signal to the electronic controller to increase an oscillation count.

15. The automotive vehicle of claim 14, wherein the predetermined frequency range is 10-14 Hz.

16. The automotive vehicle of claim 14, wherein the electronic controller is further configured to transmit a diagnostic notification if the oscillation count is above a predetermined count threshold.

17. The automotive vehicle of claim 16, wherein transmitting the diagnostic notification comprises one or more of setting a diagnostic code and displaying a notification.

18. The automotive vehicle of claim 14, wherein the electronic controller is further configured to compare the oscillation count to a predetermined count threshold.

19. The automotive vehicle of claim 18, wherein comparing the oscillation count to the predetermined count threshold comprises comparing the oscillation count to the predetermined count threshold over a predetermined interval.
